(19) United States
(12) Patent Application Publication
(10) Pub. No.: US 2026/0177098 A1
(43) Pub. Date: Jun. 25, 2026

(54) SECURE POCKET HOOK WITH INTEGRATED LOCKING MECHANISM

(71) Applicant: Nite Ize, Inc., Boulder, CO (US)

(72) Inventor: Gregory M. ADELMAN, Boulder, CO (US)

(21) Appl. No.: 18/989,016

(22) Filed: Dec. 20, 2024

(51) Int. Cl. F16B 45/02; A45F 5/00; A45F 5/02

(52) U.S. Cl. CPC F16B 45/023; A45F 5/022; A45F 5/1558

(57) ABSTRACT

A pocket hook including a unitary body defining an elongated slot and hole. The slot forms an opening at a front side of the body and the front side of the body defines a gate rest notch facing the slot. A gate extension at least partially defines the opening. The pocket hook includes a gate pivotably coupled to a rear side of the body, and the gate is configured to selectively move between a closed position and an open position. In the closed position, a free end of the gate is received within the gate rest notch. In the open position, the free end of the gate is disposed within the slot. A lower surface of the gate rest extension may define an acute angle with respect to a longitudinal axis defined within the slot.

### FIELD

This disclosure generally relates to pocket hooks. More specifically, some embodiments relate to pocket hooks with a locking mechanism.

### BACKGROUND

It may be desirable to secure a pocket hook to fabric, such as fabric of a pocket. In some examples, it may be desirable to secure a pocket hook to fabric using a gate coupled to the pocket hook.

### SUMMARY

Some embodiments described herein are directed to a pocket hook, including a unitary body defining an elongated slot and a hole. The slot may form an opening at a front side of the body, and the front side of the body may define a gate rest notch facing the slot. A gate rest extension may at least partially define the opening. The pocket hook may include a gate pivotably coupled to a rear side of the body, and the gate may be configured to selectively move between a closed position and an open position. In the closed position, a free end of the gate may be received within the gate rest notch, and in the open position, the free end of the gate may be disposed within the slot. A lower surface of the gate rest extension may define an acute angle with respect to a longitudinal axis defined within the slot.

In some embodiments, a body length may be defined longitudinally between a top side and a bottom side of the body that may be greater than a body width defined laterally between the front and rear sides of the body. The pocket hook may have a ratio of body length to body width between 1.5 and 6. In some embodiments, the body length may be between 1 inch and 3 inches.

The pocket hook may also include a front side length defined between the top of the front side and a bottom of the gate rest extension. The front side length may be shorter than the body length. In some embodiments, a ratio between the front side length and the body length may be between 0.65 and 1.

In some embodiments, the gate rest extension may extend outwardly relative to the front side. In some embodiment, the angle may be between 85 degrees and 15 degrees. A bottom portion of the gate rest notch may form a barb extending towards the slot. In some embodiments, gate rest notch forms a notch in the front side of the body, the notch being defined by a top wall, a bottom wall. Gate rest notch may form a longitudinal wall disposed between the top and bottom wall, and a top angle may be defined between the longitudinal wall and the top wall that may be greater than a bottom angle defined between the longitudinal wall and the bottom wall. In some embodiments, the bottom angle is less than or equal to 90 degrees.

The hole of the pocket hook may be positioned longitudinally lower than the gate. In some embodiments, the opening defines an entry pathway into the slot, and the entry pathway may be angled toward the front side of the body. In some embodiments, the entry pathway may be defined between two facing interior surfaces that are within 5 degrees of parallel to each other, and one of the facing interior surfaces may be an interior surface of the gate rest extension. In some embodiments, a width of the entry pathway decreases toward the slot. The entry pathway may be configured to receive an item while the gate is closed, and the gate may be configured to be pushed open by the item as the item moves from the entry pathway to the slot. In some embodiments, the gate is configured to move into a second closed position with an item sandwiched between the gate and the gate rest notch.

Some embodiments described herein are directed to a pocket hook, including a unitary body defining an elongated slot and a hole, and the slot may form an opening at a front side of the body. The front side of the body may define a gate rest notch facing the slot, and a gate rest extension at least partially defining the opening. The pocket hook may include a gate pivotably coupled to a rear side of the body, the gate configured to selectively move between a closed position and an open position. In the closed position a free end of the gate may push against the gate rest notch, and the gate rest notch may be a notch in the front side of the body with a top wall, and a bottom wall. The opening may define an entry pathway into the slot, and the entry pathway may be angled toward the front side of the body.

The bottom wall may form a projection extending towards the slot and configured to snag on fabric. In some embodiments, the gate may be biased to the closed position, and the entry pathway may be configured to receive an item while the gate is closed. The gate may be configured to be pushed open by the item as the item moves from the entry pathway to the slot. In some embodiments, when the gate is in the closed position the free end of the gate is configured to pinch fabric in the gate rest notch or abut the gate rest notch.

### BRIEF DESCRIPTION OF THE FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 shows a side view of an embodiment of a pocket hook with a gate in the closed position.

FIG. 2 shows a side view of the pocket hook of FIG. 1 with the gate in an open position.

FIG. 3 shows a side view of a second embodiment of a pocket hook with a gate in the closed position.

FIG. 4 shows a side view of a pocket hook with the gate in an open position.

FIG. 5 is a partial view of a pocket hook zoomed in on the gate rest notch and gate rest extension.

FIG. 6 is a side perspective view of a pocket hook with fabric abutting the gate.

FIG. 7 is a side perspective view of a pocket hook with fabric partially extending into an elongated slot.

FIG. 8 is a side perspective view of a pocket hook with fabric extending to a top side of an elongated slot.

FIG. 9 is a side perspective view of an embodiment of the pocket hook of FIG. 1 with a barbed gate rest notch.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein comport with standards used by those experienced or skilled in the art to most effectively convey the substance of their work to others skilled in the art. In some instances, well-known methods, procedures, and components have not been described in detail to avoid unnecessarily obscuring aspects of the disclosure.

References in the specification to “some embodiments” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to apply such feature, structure, or characteristic in connection with other embodiments whether or not explicitly described.

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

People may use pocket hooks to secure items in their pocket. It is often desirable for pocket hooks to be shaped so they do not take up too much space in a pocket. For example, a user may desire a pocket hook with a slim or narrow shape to maximize the amount of available storage room in the pocket. Pocket hooks may be shaped to leave room for other items to be stored in the pocket, such as the items attached to the pocket hook, in addition to other items, such as a phone, or wallet. Keys may be coupled to a pocket hook, and the user may want a pocket hook shaped so both the pocket hook and keys comfortably fit in a traditionally sized pocket.

When a pocket hook is too bulky or heavy, it may be uncomfortable for a user or may weigh the pocket down, which may dissuade the user from using the bulky or heavy pocket hook. A user may also be dissuaded from using a pocket hook that is too long-because the pocket hook may protrude out of the top of the pocket- or too short-because the pocket hook may not have the depth to secure well to the pocket or position attached contents deeply enough in the pocket. This may undesirably draw attention to the ill-fitted pocket hook, and may cause the pocket hook to and have an unsecure fit.

In addition to being shaped for a pocket and to take up limited space in the pocket, it is sometimes advantageous for pocket hooks to have a secure fit. Pocket hooks are commonly attached to items of importance, such as keys. A secure pocket hook may give a user peace of mind that the pocket hook and items attached to the pocket hook are secure in the pocket. The shape of long and narrow pocket hooks may advantageously securely fit long and narrow, such as the fabric of a pocket. A pocket hook with a long and narrow shape may be more stable when attaching to long and narrow objects relative to pocket hooks with other shapes. In addition to being secure, it is often advantageous for pocket hooks to be easily attached and detached from the pocket when intended by the user, so the user can conveniently access items attached to the pocket hook, such as keys. Users may be dissuaded from using a pocket hook that is too difficult to attach and detach from a pocket.

The present disclosure provides a solution in the form of a pocket hook with an elongated slot so fabric of a pocket can be placed within the slot. The pocket hook of the present disclosure also includes a pivotable gate that extends across the elongated slot, and the gate pivots between an open and closed position. In the open position, the pocket hook may be inserted on a pocket and removed from the pocket, and in the closed position the pocket hook may be secured to the pocket by sandwiching fabric between the gate and pocket hook.

Though described mainly in the context of use with a pocket, this is for convenience of description. Pocket hooks as described herein can be used in other contexts in which a hook arrangement as described would be useful, such as for attaching to any sufficiently-narrow object (e.g., a bag, a collar, a wire fence), particularly one where the hook is hooked over a narrow top edge of something that does not have a lower opening within reach of the pocket hook (e.g., the upper edge of a fabric article like a canvas bag).

Some embodiments of the present disclosure, as described in more detail below, disclose a pocket hook with an elongated slot and a body length, defined between a top and bottom side of the body, that is greater than a body width, defined laterally between front and rear sides of the body. A pocket hook with an elongated slot and a body length that is greater than a body width may form a pocket hook shaped to securely fit on a pocket without taking up too much pocket space.

These and other embodiments are discussed below in more detail with reference to the figures.

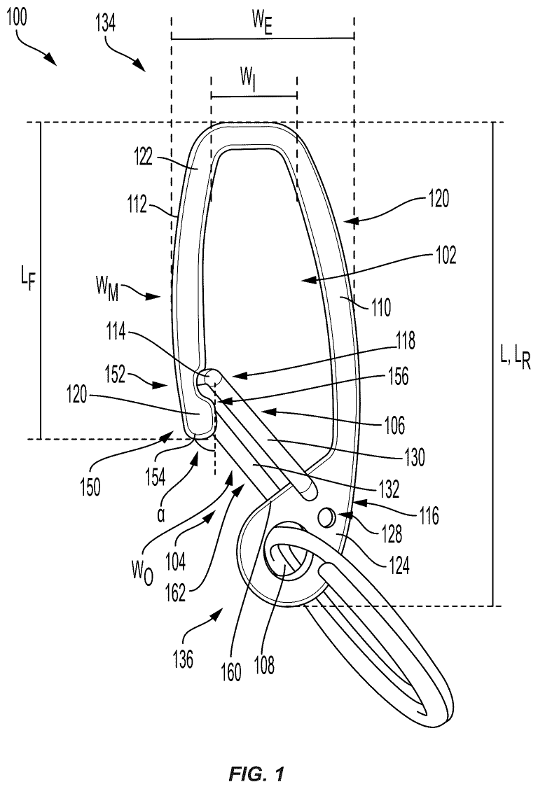

FIG. 1. shows a pocket hook 100 according to some embodiments. Pocket hook 100 may form an elongated slot 102 with an opening 104 at a front side 112 of a body 122 for accessing elongated slot 102. FIG. 1 shows pocket hook 100 with a gate 106.

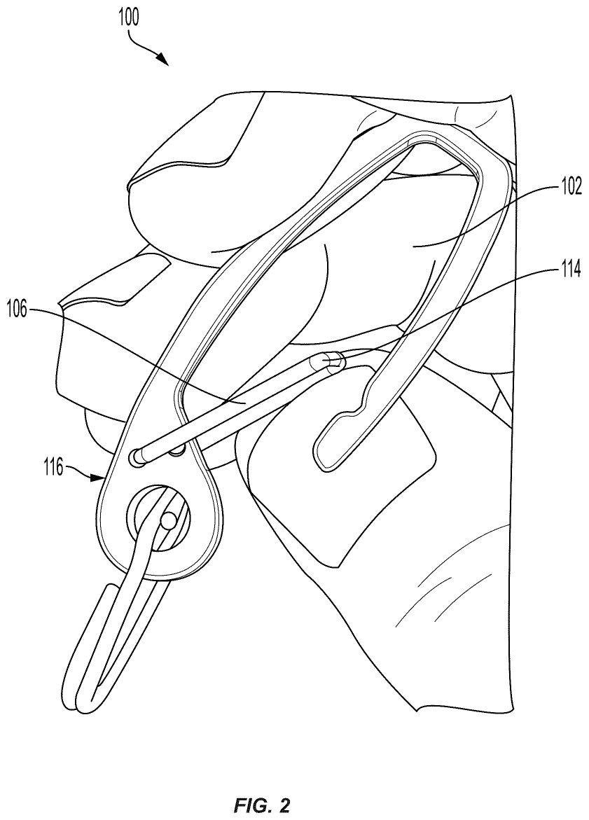

Gate 106 may be moveable. Gate 106 may be a lever. As shown, for example, in FIG. 1, gate 106 may be in a closed position. In the closed position, gate 106 may extend from a rear side 110 to front side 112 of pocket hook 100. In the closed position, gate 106 may close opening 104 or otherwise block entry to elongated slot 102 through opening 104. Gate 106 may be movable to an open position, as shown in FIG. 2. In the open position, elongated slot 102 may be accessible through opening 104. Additionally, when gate 106 is in the open position, a free end 114 of gate 106 may at least partially extend or be positioned in elongated slot 102.

In some embodiments, pocket hook 100 may be a unitary body 122, with a gate rest notch 118 defined in front side 112 of body 122 and a gate extension 124 defined in rear side 110. Gate rest notch 118 may be a notch defined in an interior surface of front side 112. Gate rest notch 118 may be a lever receptacle. Gate rest notch 118 may receive gate 106 when gate 106 is in the closed position. Gate extension may be a portion of rear side 110 that extends towards a bottom side 136 relative to gate 106. In some embodiments, pocket hook 100 may be shaped so front side 112 is shorter than rear side 110. Accordingly, gate extension 124 may extend below gate rest extension 120.

In some embodiments, gate 106 may pivot between rear side 110 and front side 112. Gate 106 may be pivotally coupled to rear side 110 of pocket hook 100. In some embodiments, gate 106 may have a hinged end 116 opposite free end 114, and hinged end 116 may be pivotally coupled to rear side 110. Gate 106 may be biased to the closed position. In other words, when no external forces are applied to pocket hook 100, (i.e., no forces are applied on the pocket hook 100 by a user) gate 106 may be in the closed position. In some embodiments, hinged end 116 may bias gate 106 to the closed position without the use of a separate spring. In some embodiments, gate 106 may act as a torsion spring that is biased to the closed position. The tension in the spring (i.e., spring tension) may bias gate 106 to the closed position. When in the closed position, free end 114 may push against gate rest notch 118.

Gate 106 may selectively move between the closed position and the open position. As explained above, gate 106 may be biased to the closed position. When in the closed position, a user may apply a force to gate 106, moving gate 106 to the open position with free end 114 positioned within elongated slot 102. When user lets go of gate 106 or stops applying a force to gate 106, the gate may move to the closed position, with free end 114 pushing against gate rest notch 118. In some examples, gate 106 may snap from the open position to the closed position.

Gate 106 may be a wire gate with a right side 130 and a left side 132. Free end 114 of gate 106 may be rectangular shaped with rounded corners. Hinged end 116 may be pivotally coupled to rear side 110 at two locations, an upper location 126 and a lower location 128. In some examples one side of gate 106 may be longer than the other side. As shown, for example, in FIG. 1, left side 132 may be longer than right side 130. In some embodiments, left side 132 may be coupled to gate extension 124 at lower location 128, and right side 130 may be coupled at upper location 126. In some embodiments, right side 130 may be longer than left side 132. In these embodiments, right side 130 may be coupled at lower location 128 and left side 132 maybe coupled to upper location 126. In some embodiments, the upper location 126 and lower location 128 may be located equally, or approximately equally, in the longitudinal direction (i.e., in the direction of length L), and may be spaced laterally (i.e., in the direction of width W_{E}).

Gate 106 may be or act as a torsion spring that is biased to the closed position. In some examples, when gate 106 is not installed in pocket hook 100, right side 130 and left side 132 are offset so right and left sides 130, 132 are not parallel. In some embodiments, right side 130 is naturally offset towards rear side 110 and left side 132 is naturally offset towards front side 112. When right and left sides 130, 132 are installed to pocket hook 100, right and left sides 130, 132 may be parallel or substantially parallel between free end 114 and hinged end 116. This may create torsion that biases gate 106 to the closed position.

In some embodiments, right side 130 may have a length between about 0.4 inches and 0.7 inches. In some examples, the length of right side 130 may be about 0.5 inches. In some embodiments, left side 132 may have a length between about 0.5 inches and 0.8 inches. In some embodiments, the length of left side 132 may be about 0.6 inches.

Gate rest notch 118 may defined in front side 112 of pocket hook 100, facing elongated slot 102. Gate rest notch 118 may receive gate 106. For example, when gate 106 is in the closed position, gate rest notch 118 may receive gate 106, and gate may exert pressure or push against gate rest notch 118. Gate rest notch 118 may be shaped so gate 106 may conveniently move in and out of gate rest notch 118. For example, gate rest notch 118 may be configured so gate 106 is not inhibited by gate rest notch 118 when moving between open and closed positions.

In some embodiments, as shown in FIG. 1, gate rest notch 118 may be a concave notch in front side 112. In some examples, in use fabric may be sandwiched between gate 106 and gate rest notch 118, such as when securing pocket hook 100 to a pocket. When gate 106 is in the closed position, gate 106 may push fabric against gate rest notch 118, securing pocket hook 100 to the fabric. In some examples, fabric may collect in gate rest notch 118. When fabric collects in gate rest notch 118, the pocket hook 100 may be more secure to the fabric than when fabric does not collect in gate rest notch 118. In some examples, when gate 106 is in the closed position with fabric between gate 106 and gate rest notch 118, a user may tug on pocket hook 100, which may further secure pocket hook 100 to the fabric. In these examples, the user may tug pocket hook 100 either in an upward or downward direction.

Pocket hook 100 may have a length L that is longer than width W_{E}. Length L may be defined longitudinally between a top side 134 and a bottom side 136 of pocket hook 100. In some embodiments, the length L is defined between the outer surface (i.e., top-most extent) of top side 134 and an outer surface (i.e., bottom-most extent) of bottom side 136. Width W_{E} may be defined laterally between the front side 112 and rear side 110. In some embodiments, as shown, for example, in FIGS. 1-2, width W_{E} may be defined between an outer surface (i.e., front-most extent) of front side 112 and an outer surface (i.e., rear-most extent) of rear side 110.

As shown in FIGS. 1-2, a front side length L_{F}, defined between top side 132 and a bottom of the gate rest extension 120 may be smaller than a rear side length L_{R}, defined between top side 134 and bottom side 136 of rear side 110. In some examples, length L may be rear side length L_{R}. In some embodiments, a ratio between front side length L_{F} and the rear side length L_{R}, or ratio L_{F}/L_{R}, may be greater than 0.5. In some embodiments, ratio L_{F}/L_{R} may be between 0.65 and 1. In some embodiments, the ratio L_{F}/L_{R} may be approximately 2/3.

Pocket hook 100 may have an internal width W_{I} defined between interior surfaces of the front and rear side 110, 112. According to some embodiments, as shown in FIG. 1, width W_{E} or W_{I} may change between top side 134 and bottom side 136 of elongated slot 102. In some embodiments, width W_{E} or W_{I} may be smallest at top side 134 of elongated slot 102. In some embodiments, width W_{E} or W_{I} may be smallest at bottom side 136 of elongated slot 102, or at bottom of front side 112. Width W_{E} or W_{I} may increase when moving down the elongated slot 102 from top side 134 towards bottom side 136 until reaching a maximum width W_{M} or a maximum internal width. Maximum width W_{M} may be the largest width W_{E} between an outer surface (i.e., front-most extent) of front side 112 and an outer surface (i.e., rear-most extent) of rear side 110. The maximum internal width may be the largest width W_{I} between an inner surface of front side 112 and an inner surface of rear side 110. Width W_{I} may be the width of elongated slot 102. After reaching maximum width W_{M} or maximum internal width, width W_{E} or W_{I} may decrease when moving from maximum width W_{M} or maximum internal width towards bottom side 136. In some examples, width W_{E} or W_{I} remains approximately the same. A pocket hook 100 that narrows near opening 104 may allow pocket hook 100 to have a low profile while accommodating a sufficiently large area within elongated slot 102 to secure over an item, such fabric or a pocket.

According to some embodiments, maximum width W_{M} may be between about 0.3 inches and 0.8 inches. In some examples, maximum width W_{M} may be between about 0.4 inches and 0.7 inches. In some examples, maximum width W_{M} may be about 0.5 inches.

In some embodiments, as shown in FIG. 2, for example, width W_{I} may be smallest at top side 112 of elongated slot 102.

In some embodiments, a ratio of length L to width W_{E} (L/W_{E}) of body 122 may be between 1.5 and 6. In some examples, length L may be between about 1.4 inches and 3 inches. In some embodiments, the length L may be between about 1.6 inches and 2.4 inches. In some embodiments, the length L may be about 2.2 inches.

Body 122 of pocket hook 100 may extend below gate rest notch 118, forming gate rest extension 120. Gate rest extension 120 may be a lead-in. Gate rest extension 120 may extend below gate rest notch 118 towards bottom side 136. Gate rest extension 120 may at least partially define opening 104. For example, opening 104 may be defined between gate rest extension 120 and gate extension 124, which is adjacent to gate 106. Opening 104 may define an entry pathway 162 into elongated slot 102, and the entry pathway 162 may be angled toward front side 112 of the body 122.

Entry pathway 162 may be defined between lower surface 154 and inner surface 160. Entry pathway 162 may guide fabric towards gate 106. In some examples, entry pathway may receive an item, such as fabric, for example, while gate 106 is in the closed position. The fabric may push gate 106 to the open position and slide past entry pathway 162 into elongated slot 102. In some embodiments, entry pathway 162 may decrease toward elongated slot 102.

A bottom portion of front side 112 that extends below gate rest notch 118 may define the gate rest extension 120. As shown in FIG. 1, front side 112 may have a concave shape, and gate rest extension 120 may form a portion of the concave shape. In some embodiments, gate rest extension 120 may be curved inward. Gate rest extension 120 may have rounded edges. The rounded edges may minimize fabric getting snagged on the edges, and may minimize any poking of the user or of fabric.

A lower surface 154 of gate rest extension 120 may form an angle α with a longitudinal axis 156. In some embodiments, as illustrated in FIG. 1, angle α may be an acute angle, or an angle less than 90° defined between lower surface 154 and longitudinal axis 156, longitudinal axis being defined within elongated slot 102. In some embodiments, angle α may be between approximately 10° and 70°. In some embodiments, angle α may be between approximately 12° and 40°. In some embodiments, angle α may be approximately 27°. Lower surface 154 may be angled so lower surface 154 and an inner surface 160 of gate extension 124 are approximately parallel. In some embodiments, inner surface 160 and lower surface 154 may be within approximately 5° of parallel with each other. Lower surface 154 and inner surface 160 may be directed towards elongated slot 102. This combination of lower surface 154 being parallel to inner surface 160 and both surfaces 154, 160 being directed towards elongated slot 102 makes it easier for a user to guide fabric through opening 104 towards gate 106 and elongated slot 102.

In some embodiments, lower surface 154 and inner surface 160 may converge towards elongated slot 102, which may guide fabric through opening 104 towards gate 106 and towards elongated slot 102. In some examples, an opening width W_{O} may be defined between lower surface 154 and inner surface 160. In some examples, opening width W_{O} may be approximately the same at front of opening 104 and rear of opening 104. In some examples, opening width W_{O} may be largest near front of opening 104 and may be smallest near rear of opening 104. Opening width W_{O} may decrease towards the slot.

When lower surface 154 converges with inner surface 160 towards elongated slot 102, opening 104 also converges towards elongated slot 102. Pocket hooks 100 with openings 104 that converge towards elongated slot 102 may maintain the slim or narrow shape and secure fit of the pocket hook 100, while making it easy for a user to position fabric within opening 104.

As shown, for example, in FIGS. 1-2, hole 108 may be formed in pocket hook 100. Hole 108 may be an eyelet for securing an article such as a split ring or other link. Hole 108 may be for securing an item to pocket hook 100. For example, one or more split rings or other links may be secured to the pocket hook 100 through hole 108, and items, such as keys, may be attached to the split ring. In some embodiments, hole 108 may be formed in gate extension 124, such that hole 108 is positioned below gate 106. Hole 108 may be positioned longitudinally lower than gate 106. Hole 108 may be sized to receive one or more split rings, and may be small enough that a typical adult thumb cannot fit through the hole 108. In some embodiments, a user may grab gate extension 124 with their thumb positioned over hole 108, and may pull pocket hook 100.

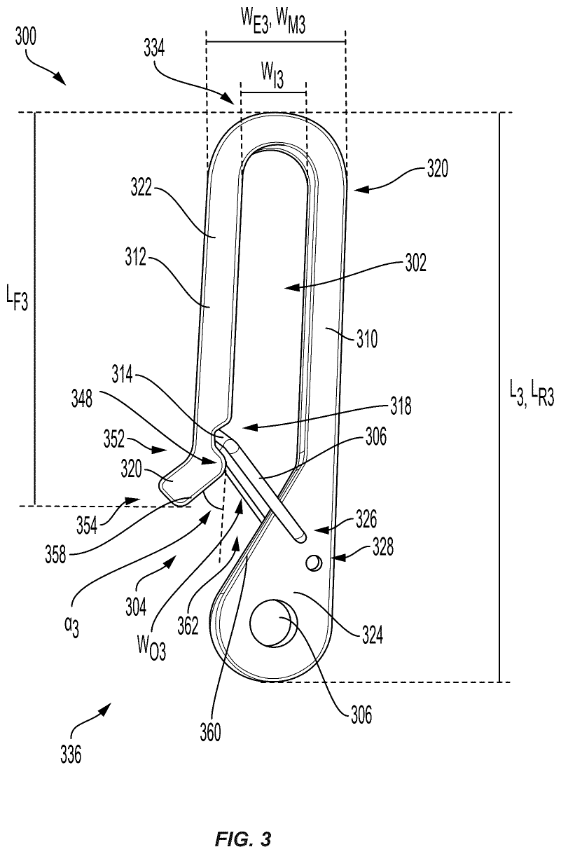

Referring now to FIG. 3, a pocket hook 300 is illustrated. Pocket hook 300 may be similar to pocket hook 100. The above description relating to elements and features of pocket hook 100 also applies to corresponding elements and features of pocket hook 300. For example, pocket hook 300 may have an elongated slot 302 defined between a rear side 310 and front side 312 of a body 322, with an opening 304 that defines an entry pathway 362 which may guide fabric towards gate 306 and towards elongated slot 302. Gate 306 may move between an open and closed position. A free end 314 of gate 306 may rest on a gate rest notch 318 in the closed position, and free end 314 may be positioned within elongated slot 302 in the open position. A gate rest extension 320 may extend below gate rest notch 318 towards bottom side 336.

Similar to gate 106, gate 306 may have a hinged end 316 opposite free end 314, and hinged end 316 may be pivotally coupled to rear side 310. In some examples, hinged end 316 may be coupled to rear side 310 at an upper location 326 and a lower location 328. In some examples, gate 306 may have a right side 330 and a left side 332, and left side 332 may be longer than right side 330. Gate extension 324 may extend below gate 306. In some embodiments, a hole 308 may be formed in gate extension 324, such that hole 308 is positioned below gate 306.

Pocket hook 300 may have similar dimension characteristics as dimension characteristics of pocket hook 100. For example, pocket hook 300 may have a length L₃ that is larger than a maximum width W_{M3}. As shown in FIG. 3, for example, length L₃ may be rear side length L_{R3}, which may be defined between a top side 334 and bottom side 336 of body 322. Maximum width W_{M3} may be defined between right side 330 and left side 332. A front side length L_{F3}, defined between top side 332 and a bottom of a gate rest extension 320 may be smaller than a rear side length L_{R3}, defined between top side 334 and bottom side 336 of rear side 310.

Similar to pocket hook 100, pocket hook 300 may have a width W_{E3} defined between an outer surface (i.e., front-most extent) of front side 112 and an outer surface (i.e., rear-most extent) of rear side 110. Pocket hook 300 may also have an internal width W_{I3} defined between interior surfaces of the front and rear side 310, 312. In some examples, width W_{E} or W_{I} may be the same, or approximately the same, moving between top side 134 and bottom side 136 of elongated slot 102. In some embodiments, width W_{E} or W_{I} of elongated slot 102 may remain approximately unchanged along a majority of elongated slot 102. A pocket hook 100 that remains approximately the same near opening 104 may allow pocket hook 100 to have a low profile while accommodating a sufficiently large area within elongated slot 102 to secure over an item, such fabric or a pocket.

In some examples, as shown in FIGS. 3-5, gate rest notch 318 may be formed in front side 312, and may have a longitudinal wall 338 defined between a top wall 340 and a bottom wall 342. Top wall 340 may slope away from elongated slot 302. In other words, as top wall 340 extends towards longitudinal wall 338, top wall 340 may extend towards bottom side 336 and front side 312. In some embodiments, longitudinal wall 338 may extend longitudinally between top wall 340 and bottom wall 342. Bottom wall may extend from longitudinal wall 338 towards elongated slot 302 or towards opening 304.

In some examples, as shown in FIG. 3, gate rest extension 120 may flare outward, or away from elongated slot 102. A bottom 150 of gate rest extension 120 may extend further outward relative to a top 152 of gate rest extension 120. In some embodiments, bottom 150 may extend or flare further outward relative to the rest of front side 112.

When inner surface 358 converges with inner surface 160 towards elongated slot 102, opening 104 also converges towards elongated slot 102. Pocket hooks 100 with openings 104 that converge towards elongated slot 102 may maintain the slim or narrow shape and secure fit of the pocket hook 100, while making it easy for a user to position fabric within opening 104.

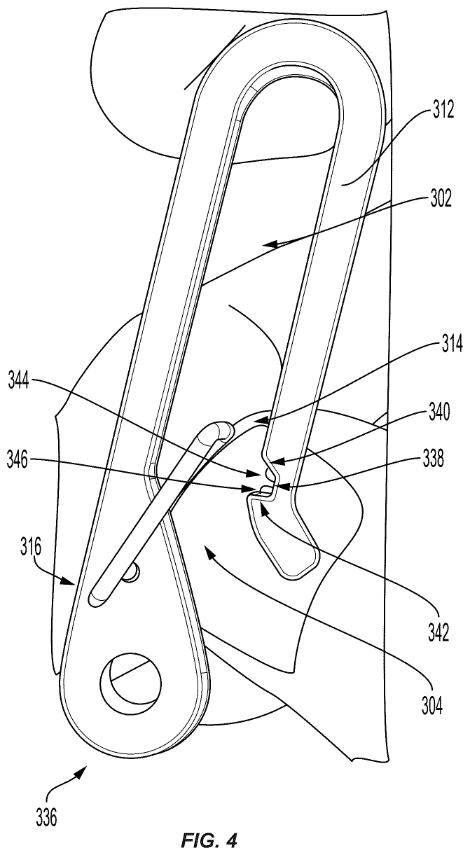

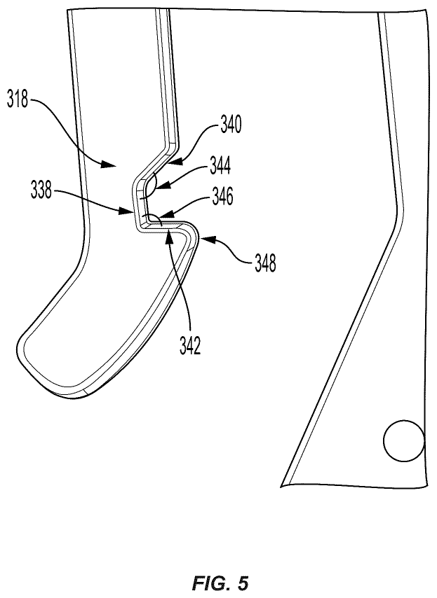

As illustrated in FIGS. 4-5, in some embodiments a top angle 344 of gate rest notch 318 may be defined between top wall 340 and longitudinal wall 338, and a bottom angle 346 of gate rest notch 318 may be defined between longitudinal wall 338 and bottom wall 342. Top angle 344 may be between approximately 90° and 180°. In some embodiments, top angle 344 may be between approximately 110° and 150°. In some embodiments, top angle 344 may be approximately 135°. Top angle 344 may be greater than bottom angle 346. In some embodiments, bottom angle 346 may an acute angle, or less than or equal to approximately 90°. In some embodiments, top angle 344 may be between approximately 45° and 100°. In some embodiments, bottom angle 346 may be between approximately 80° and 100°. In some examples, bottom angle 346 may be approximately 90°.

Bottom wall 342 may form a projection extending into elongated slot 302, forming a barb 348. Barb 348 may be configured to snag on fabric. For example, when fabric moves from top side 334 towards bottom side 336, barb 348 may snag fabric, causing fabric to collect in gate rest notch 318, thereby securing the pocket hook 300 to the fabric.

According to some embodiments, as illustrated in FIG. 3, an angle α₃ may be formed between an inner surface 358 of gate rest extension 320 and a longitudinal axis 356. In some embodiments, angle α₃ of be less than about 90°. In some embodiments, angle α₃ may be between approximately 10° and 70°. In some embodiments, the angle α₃ may be between about 12° and 40°. According to some embodiments, α₃ may be approximately 27°. Similar to lower surface 154, inner surface 358 may be parallel, or approximately parallel to an inner surface 360 of gate extension 324. Inner surfaces 358, 360 may be directed towards elongated slot 302, which may make it easier for a user to guide fabric through opening 304 towards gate 306 and elongated slot 302. In some embodiments, inner surfaces 358, 360 may be within approximately 5° of parallel with each other.

In some embodiments, inner surfaces 358, 360 may converge towards elongated slot 302, which may guide fabric through opening 304 towards gate 306 and towards elongated slot 302. In some examples, an opening width W_{O3} may be defined between an inner surface 358 and inner surface 360. In some examples, opening width W_{O3} may be approximately the same at front of opening 304 (away from gate 306) and rear of opening 304 (near gate 306). In some examples, opening width W_{O3} may be largest near front of opening 304 and may be smallest near rear of opening 304. Opening width W_{O3} may decrease towards the slot.

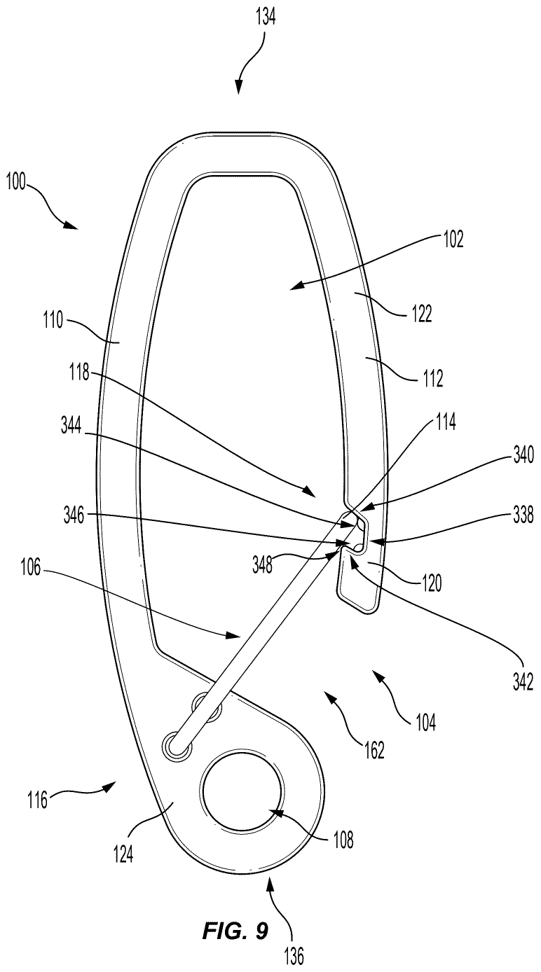

The features of gate rest notch 338 may also be applied to the configuration of pocket hook 100, as shown, for example, in FIG. 9.

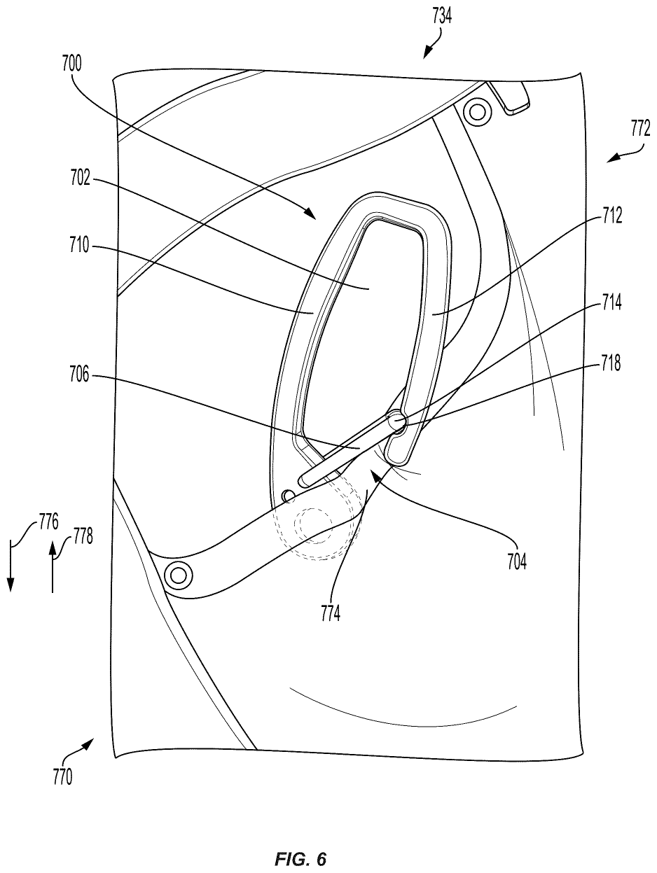

FIGS. 6-8 illustrate an example use case for securing a pocket hook 700 in a pocket. As shown, a fabric 770 is guided into an opening 704, fabric 770 moves past a gate 706, and fabric 770 is slid towards a top side 734 of an elongated slot 702. Pocket hook 700 may be or be similar to pocket hook 100 or 300. For example, pocket hook 700 may have elongated slot 702 disposed between a rear side 710 and a front side 712, and an opening 704 disposed at a front side 712 of pocket hook 700. A gate rest notch 718 may be defined in front side 712, and may accept a free end 714 of gate 706. Gate 706 may be positioned between opening 704 and elongated slot 702, and may be moved between a closed position, with gate 706 resting on gate rest notch 718, and an open position, with free end 714 of gate 706 positioned within elongated slot 702.

In some embodiments, as in FIG. 6, pocket hook 700 may be partially placed in a pocket 772. For example, a bottom side 136 of pocket hook 700 may be placed within pocket 772, and top side 734 of pocket hook 700 may extend out of pocket 772. Note that portions of pocket hook 700 that are within the pocket are shown in phantom lines. An exterior portion 774 of fabric 770 may be guided into opening 704, exterior portion 774 may abut gate 706. Opening 704 may receive an item, such as fabric 770, when gate 706 is in the closed position. In some embodiments gate 706 may be biased into the closed position.

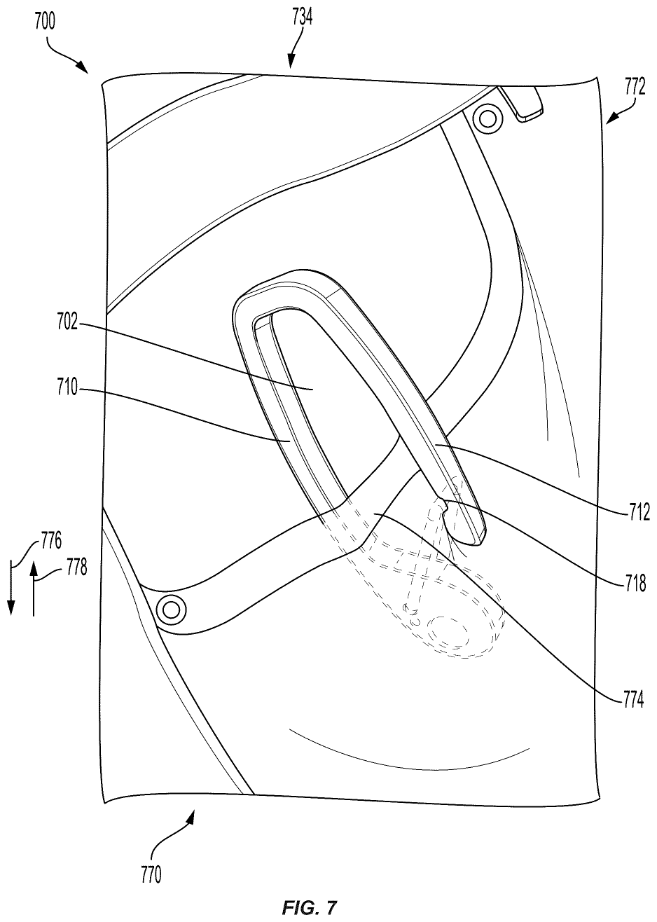

A user may then pull or push pocket hook 700 deeper into pocket 772 by exerting a force in a downward direction 776. Gate 706 may be pushed open by an item, such as fabric 706, as the item moves from the opening 706 to the elongated slot 702. For example, when a force in the downward direction 776 is exerted on pocket hook 700, fabric 770 may exert a force in the upward direction 778 on gate 706 that moves gate 706 from the closed position to the open position. The force exerted by fabric 770 on gate 706, in the upward direction 778, may overcome gate's bias to the closed position, and the fabric force may move gate 706 to the open position. With gate 706 in the open position, fabric 770 may move into elongated slot 702, as shown, for example, in FIG. 7. When fabric 770 is in elongated slot 702, fabric may be positioned between gate 706 and front side 712. In some embodiments, fabric 770 may be positioned between free end 714 of gate 706 and gate rest notch 718.

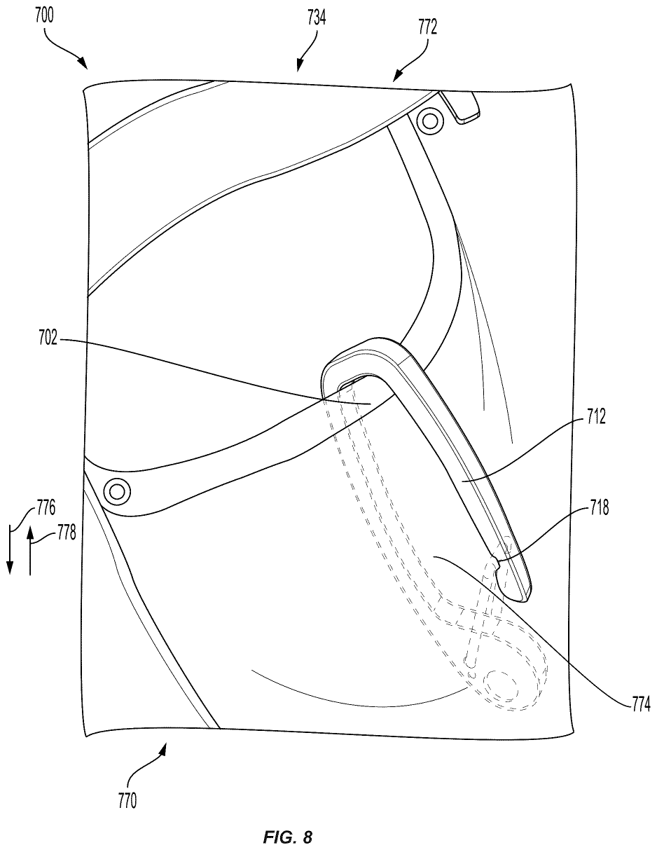

In some embodiments, rear side 710 of pocket hook 700 may slide into pocket 772 until fabric 770 is near top side 734 of elongated slot 702. In some examples, as in FIG. 8, pocket hook 700 may be moved in the downward direction 776 into pocket 772 until fabric 770 abuts top side 734 of elongated slot 702. Gate 706 may push fabric 770 against front side 712, thereby securing pocket hook 700 to fabric 770. The biasing force of gate 706 that biases gate 706 to the closed position may sandwich fabric 770 between free end 714 of gate 706 and gate rest notch 718. In some examples, gate 706 may have a first closed position, where gate 706 is positioned against, or abuts, gate rest notch 718, and a second closed position, where fabric 770 is sandwiched or pinched between gate 706 and gate rest notch 718.

In some embodiments, when fabric 770 is positioned towards top side 734 of elongated slot 702, a user may pull pocket hook 700 in the upward direction 778 (e.g., in a direction tending toward removal of pocket hook 700 from the pocket). When pocket hook 700 is pulled in the upward direction 778, gate 706 may exert additional force against front side 712, thereby further securing pocket hook 700 to fabric 770. In some embodiments, when pocket hook 700 is pulled in the upward direction 778, fabric may bunch up in gate rest notch 718, thereby further securing pocket hook 700 to fabric 770.

In some embodiments, pocket hook 700 may have barb 348 (see, for example, FIGS. 3 and 5). In these embodiments, pulling pocket hook 700 in upward direction 778 when fabric 770 is positioned in elongated slot 702 may further secure pocket hook 700 to fabric 770. As fabric 770 moves in the downward direction 778 relative to pocket hook 700, barb 348 may snag fabric 770 and fabric 770 may bunch up in gate rest notch 718. According to some examples, when pocket hook 700 is pulled in upward direction 778, fabric 770 may move deeper into gate rest notch 718 and additional fabric may be moved into gate rest notch 718, thereby further securing pocket hook 700 to fabric 770.

In some embodiments, pocket hook 700 may be removed from fabric 770 by moving the gate 706 to the open position and sliding the pocket hook 700 in the upward direction 778 out of pocket 772.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

What is claimed is:

1. A pocket hook, comprising:
a unitary body defining an elongated slot and a hole, wherein the slot forms an opening at a front side of the body, and wherein the front side of the body defines a gate rest notch facing the slot, and a gate rest extension at least partially defining the opening,
a gate pivotably coupled to a rear side of the body, the gate configured to selectively move between a closed position and an open position, wherein in the closed position a free end of the gate is received within the gate rest notch, and wherein in the open position the free end of the gate is disposed within the slot, and
wherein a lower surface of the gate rest extension defines an acute angle with respect to a longitudinal axis defined within the slot.

2. The pocket hook of claim 1, wherein a body length defined longitudinally between a top side and a bottom side of the body is greater than a body width defined laterally between the front and rear sides of the body.

3. The pocket hook of claim 2, wherein a ratio of body length to body width is between 1.5 and 6.

4. The pocket hook of claim 2, wherein the body length is between 1 inch and 3 inches.

5. The pocket hook of claim 2, further comprising a front side length defined between the top of the front side and a bottom of the gate rest extension,
wherein the front side length is shorter than the body length, and
wherein a ratio between the front side length and the body length is between 0.65 and 1.

6. The pocket hook of claim 1, wherein the gate rest extension extends outwardly relative to the front side.

7. The pocket hook of claim 1, wherein the angle is between 85 degrees and 15 degrees.

8. The pocket hook of claim 1, wherein a bottom portion of the gate rest notch forms a barb extending towards the slot.

9. The pocket hook of claim 1, wherein the gate rest notch forms a notch in the front side of the body, the notch being defined by a top wall, a bottom wall, and a longitudinal wall disposed between the top and bottom wall,
wherein a top angle defined between the longitudinal wall and the top wall is greater than a bottom angle defined between the longitudinal wall and the bottom wall.

10. The pocket hook of claim 9, wherein the bottom angle is less than or equal to 90 degrees.

11. The pocket hook of claim 1, wherein the hole is positioned longitudinally lower than the gate.

12. The pocket hook of claim 1, wherein the opening defines an entry pathway into the slot, and wherein the entry pathway is angled toward the front side of the body.

13. The pocket hook of claim 12, wherein the entry pathway is defined between two facing interior surfaces that are within 5 degrees of parallel to each other, and wherein one of the facing interior surfaces is an interior surface of the gate rest extension.

14. The pocket hook of claim 12, wherein a width of the entry pathway decreases toward the slot.

15. The pocket hook of claim 12, wherein the entry pathway is configured to receive an item while the gate is closed, and wherein the gate is configured to be pushed open by the item as the item moves from the entry pathway to the slot.

16. The pocket hook of claim 1, wherein the gate is configured to move into a second closed position with an item sandwiched between the gate and the gate rest notch.

17. A pocket hook, comprising:
a unitary body defining an elongated slot and a hole, wherein the slot forms an opening at a front side of the body, and wherein the front side of the body defines a gate rest notch facing the slot, and a gate rest extension at least partially defining the opening,
a gate pivotably coupled to a rear side of the body, the gate configured to selectively move between a closed position and an open position, wherein in the closed position a free end of the gate pushes against the gate rest notch,
wherein the gate rest notch is a notch in the front side of the body with a top wall, and a bottom wall, and
wherein the opening defines an entry pathway into the slot, and wherein the entry pathway is angled toward the front side of the body.

18. The pocket hook of claim 17, wherein the bottom wall forms a projection extending towards the slot and configured to snag on fabric.

19. The pocket hook of claim 17, wherein the gate is biased to the closed position, and
wherein the entry pathway is configured to receive an item while the gate is closed, and wherein the gate is configured to be pushed open by the item as the item moves from the entry pathway to the slot.

20. The pocket hook of claim 17, wherein when the gate is in the closed position the free end of the gate is configured to pinch fabric in the gate rest notch or abut the gate rest notch.
